(19) United States
(12) Patent Application Publication
(10) Pub. No.: US 2012/0166713 A1
(43) Pub. Date: Jun. 28, 2012

(54) ADMINISTRATION DEVICE, ADMINISTRATION METHOD, AND PROGRAM

(75) Inventors: Shusuke SAEKI, Tokyo (JP); Kenji FUDONO, Tokyo (JP); Nobuhiro KANEKO, Kanagawa (JP); Hiroki NAGAHAMA, Tokyo (JP); Kazunori YAMAMOTO, Tokyo (JP)

(73) Assignee: Sony Corporation, Tokyo (JP)

(21) Appl. No.: 13/313,440

(22) Filed: Dec. 7, 2011

(30) Foreign Application Priority Data
Dec. 22, 2010 (JP) 2010-286318

(51) Int. Cl. G06F 12/02

(52) U.S. Cl. 711/103; 711/E12.008

(57) ABSTRACT

An administration device includes an administration section. The administration section administers writing, reading, and erasing of data in a nonvolatile memory, in which the data can be electrically written, read, and erased and the writing and the reading are performed on a page-by-page basis and the erasing is performed on a block-by-block basis, by translating a logical address into a physical address on a per translation unit basis; and performs fold processing of increasing unwritten physical translation units by the number of written invalid physical translation units, which are contained in a block of a copy source, by copying data of written valid physical translation units among the contents of the block into a block, in which the unwritten physical translation units reside, and by erasing the block of the copy source.

### BACKGROUND

The present disclosure relates to an administration device, an administration method, and a program.

Recently, increase in volume of a nonvolatile memory, such as the NAND flash memory, in which data can be electrically written, read, and erased has been progressing. Here, in the nonvolatile memory like the NAND flash memory, the writing is performed by unidirectionally rewriting each bit from “1” to “0”. Hence, when data is newly written in the nonvolatile memory, it is necessary to perform erasing temporarily so as to change all bits to “1” and then perform writing. Further, in the nonvolatile memory, the minimum unit of reading/writing of data is a “page”, and the minimum unit of erasing is a “block” in which a plurality of pages are collected. As described above, the size of the “block”, which is the minimum unit of erasing, is, for example, about several tens of times larger than the size of the “page” which is the minimum unit of writing. Hence, in order to further efficiently perform rewriting of data in the nonvolatile memory, a certain structure is necessary.

In such a situation, there has been developed a technique for increasing efficiency in rewriting of data in the nonvolatile memory. For example, Japanese Unexamined Patent Application Publication No. 2009-116601 discloses a technique of administering access to the nonvolatile memory by translating the logical address into the physical address translation on a per translation unit basis having a size equal to 1/n of the size of the block where n is an integer and an integer multiple of the size of the page, and newly increasing unused physical translation units by the number of invalid physical translation units contained in the original block by copying the in-use physical translation units among the contents of the block into a block, in which separate unused physical translation units reside, and by erasing the original block.

### SUMMARY

In the related art for increasing efficiency in rewriting of data in the nonvolatile memory (hereinafter simply referred to as the “related art”), the data of the physical translation units in the nonvolatile memory is copied, and the corresponding block (the copy source block) is erased. Accordingly, when the related art is used, in the block, as the number of the written invalid physical translation units (the physical translation units in which invalid data is written) is larger, it is possible to increase a free space in which data can be written.

Here, for example, from the viewpoint of a user who uses the nonvolatile memory as a data recording medium (hereinafter simply referred to as a “user”), efficiently securing the free space contributes to improvement in performance of data rewriting in the nonvolatile memory and an increase in lifetime of the nonvolatile memory such as the NAND flash memory. However, in the related art, there is no consideration for an increase of efficiency in securing the free space.

The disclosure has been made in view of the above problem, where it is desirable to provide a new and improved administration device, an administration method, and a program therefor capable of increasing efficiency in securing the free space in the nonvolatile memory.

According to a first embodiment of the disclosure, there is provided an administration device including an administration section. The administration section administers writing, reading, and erasing of data in a nonvolatile memory, in which the data can be electrically written, read, and erased and the writing and the reading are performed on a page-by-page basis and the erasing is performed on a block-by-block basis where each block includes a plurality of pages, by translating a logical address into a physical address on a per translation unit basis having a size equal to 1/n of a size of the block where n is an integer and an integer multiple of a size of the page. In addition, the administration section performs fold processing of increasing unwritten physical translation units by the number of written invalid physical translation units, which are contained in a block of a copy source, by copying data of written valid physical translation units among the contents of the block into a block, in which the unwritten physical translation units reside, and by erasing the block of the copy source. When initiating the fold processing, the administration section copies the data of the written valid physical translation units into a block, in which a first physical translation unit is unwritten, among blocks, in which the unwritten physical translation units reside, and repeats the fold processing until a size of the unwritten physical translation units increased through the fold processing is equal to or greater than a size of the block.

With such a configuration, it is possible to increase efficiency in securing the free space in the nonvolatile memory.

Further, after the fold processing is performed, when the size of the unwritten physical translation units increased through the fold processing is indivisible by the size of the block, the administration section may copy the data of the written valid physical translation units through the fold processing by the size of the unwritten physical translation units corresponding to a size of a fraction thereof.

Furthermore, the administration device may further include a determination section that determines whether or not an initiation condition for initiating the fold processing in the administration section is satisfied. The administration section may selectively perform the fold processing when the determination section determines that the initiation condition is satisfied.

Further, the determination section may perform the determination under the initiation condition in which a write location of data most recently written by the administration section is a last physical translation unit in the block and the number of the blocks of data being written is greater than a predetermined threshold value or is not less than the threshold value.

In addition, the determination section may perform the determination under the initiation condition in which the writing, the reading, and the erasing of data is not performed in the nonvolatile memory.

Further, the determination section may perform the determination under the initiation condition in which a write location of data most recently written by the administration section is a last physical translation unit in the block and the number of the blocks not containing written data is less than a predetermined threshold value or is not more than the threshold value.

Furthermore, the administration section may not stop the fold processing even when the size of the unwritten physical translation units increased through the fold processing is equal to or more than the size of the block, and may repeat the fold processing until the size of the unwritten physical translation units is equal to or more than a predetermined integer multiple of the size of the block.

In addition, the administration section may select a block, in which the number of the written invalid physical translation units is larger, among the blocks in the nonvolatile memory as a block of a copy source in the fold processing.

Further, when performing the fold processing, the administration section may cause a block including a physical translation unit, which corresponded to a logical translation unit containing most recently written data before the most recent writing, to not be subjected to the fold processing.

Furthermore, when performing the fold processing, the administration section may copy the data of the written valid physical translation units within the block in ascending order of numbers which are respectively assigned to the physical translation units.

In addition, when performing the fold processing, the administration section may copy the data of the written valid physical translation units within the block in ascending order of numbers which are respectively assigned to the physical translation units.

Further, when performing the fold processing, the administration section may specify the written valid physical translation units in all the blocks as the copy sources in the fold processing repeatedly performed, and may copy data of the specified physical translation units in ascending order of numbers which are respectively assigned to the logical translation units respectively corresponding to the specified physical translation units.

The administration device may further include the nonvolatile memory.

According to a second embodiment of the disclosure, there is provided an administration method including the steps of: administering writing, reading, and erasing of data in a nonvolatile memory, in which the data can be electrically written, read, and erased and the writing and the reading are performed on a page-by-page basis and the erasing is performed on a block-by-block basis where each block includes a plurality of pages, by translating a logical address into a physical address on a per translation unit basis having a size equal to 1/n of a size of the block where n is an integer and an integer multiple of a size of the page; and determining whether or not an initiation condition is satisfied, where the condition is for initiating fold processing of increasing unwritten physical translation units by the number of written invalid physical translation units, which are contained in a block of a copy source, by copying data of written valid physical translation units among the contents of the block into a block, in which the unwritten physical translation units reside, and by erasing the block of the copy source. In the administering of the writing, the reading, and the erasing, if it is determined that the initiation condition is satisfied, the fold processing is selectively performed. When the fold processing is initiated, the data of the written valid physical translation units is copied into a block, in which a first physical translation unit is unwritten, among blocks in which the unwritten physical translation units reside, and the fold processing is repeated until a size of the unwritten physical translation units increased through the fold processing is equal to or greater than a size of the block.

By using such a method, it is possible to increase efficiency in securing the free space in the nonvolatile memory.

According to a third embodiment of the disclosure, there is provided a program for causing a computer to function as administration means for: administering writing, reading, and erasing of data in a nonvolatile memory, in which the data can be electrically written, read, and erased and the writing and the reading are performed on a page-by-page basis and the erasing is performed on a block-by-block basis where each block includes a plurality of pages, by translating a logical address into a physical address on a per translation unit basis having a size equal to 1/n of a size of the block where n is an integer and an integer multiple of a size of the page; and performing fold processing of increasing unwritten physical translation units by the number of written invalid physical translation units, which are contained in a block of a copy source, by copying data of written valid physical translation units among the contents of the block into a block, in which the unwritten physical translation units reside, and by erasing the block of the copy source. When initiating the fold processing, the administration section copies the data of the written valid physical translation units into a block, in which a first physical translation unit is unwritten, among blocks, in which the unwritten physical translation units reside, and repeats the fold processing until a size of the unwritten physical translation units increased through the fold processing is equal to or greater than a size of the block.

By using such a program, it is possible to increase efficiency in securing the free space in the nonvolatile memory.

According to the embodiments of the disclosure, it is possible to increase efficiency in securing the free space in the nonvolatile memory.

### BRIEF DESCRIPTION OF THE DRAWINGS

FIG. 1 is an explanatory diagram illustrating a premise in a nonvolatile memory;

FIG. 2 is an explanatory diagram illustrating the premise in the nonvolatile memory;

FIG. 3 is an explanatory diagram illustrating a problem in the related art;

FIG. 4 is an explanatory diagram illustrating the problem in the related art;

FIGS. 5A to 5C are explanatory diagrams illustrating the problem in the related art;

FIGS. 6A to 6H are explanatory diagrams illustrating the problem in the related art;

FIG. 7 is an explanatory diagram illustrating the sequence of writing the data in the nonvolatile memory when fold processing is initiated by an administration device according to an embodiment of the disclosure;

FIGS. 8A to 8G are explanatory diagrams illustrating an example of multi-fold processing in the administration device according to the embodiment of the disclosure;

FIGS. 9A to 9D are explanatory diagrams illustrating another example of the multi-fold processing in the administration device according to the embodiment of the disclosure;

FIGS. 10A to 10C are explanatory diagrams illustrating another example of the multi-fold processing in the administration device according to the embodiment of the disclosure;

FIGS. 11A to 11H are explanatory diagrams illustrating another example of the multi-fold processing in the administration device according to the embodiment of the disclosure;

FIG. 12 is a flowchart illustrating an example of processing relating to an administration method according to an embodiment of the disclosure;

FIG. 13 is a flowchart illustrating an example of processing of writing data according to the embodiment of the disclosure;

FIG. 14 is a flowchart illustrating an example of multi-fold processing according to the embodiment of the disclosure;

FIG. 15 is a flowchart illustrating an example of first multi-fold processing according to the embodiment of the disclosure;

FIG. 16 is a flowchart illustrating an example of fold processing according to the embodiment of the disclosure;

FIG. 17 is a flowchart illustrating an example of second multi-fold processing according to the embodiment of the disclosure;

FIG. 18 is a block diagram illustrating an example of a configuration of the administration device according to the embodiment of the disclosure; and

FIG. 19 is an explanatory diagram illustrating an example of a hardware configuration of the administration device according to the embodiment of the disclosure.

### DETAILED DESCRIPTION OF EMBODIMENTS

Hereinafter, preferred embodiments of the disclosure will be described in detail with reference to the appended drawings. Further, in this specification and the appended drawings, components that have substantially the same function and structure are denoted with the same reference numerals, and repeated description of these components is omitted.

Further, hereinafter, description will be given in the order of the following items.

1. Administration Method According to Embodiment of the Disclosure

2. Administration Device According to Embodiment of the Disclosure

3. Program According to Embodiment of the Disclosure

### 1. Administration Method According to Embodiment of the Disclosure

Before a configuration of an administration device (hereinafter referred to as an “administration device 100”) according to an embodiment of the disclosure is described, the method of administering a nonvolatile memory according to an embodiment of the disclosure will be described. In the following description, the administration device 100 performs processing relating to the administration method according to the embodiment of the disclosure. Further, the following description will be given, as an example of a case where the nonvolatile memory subjected to administration of the administration device 100 according to the embodiment of the disclosure is a NAND flash memory. In addition, it is needless to say that the nonvolatile memory subjected to administration of the administration device 100 according to the embodiment of the disclosure is not limited to the NAND flash memory.

Premise

Before the description of the processing relating to the administration method according to the embodiment of the disclosure, the premise in the nonvolatile memory subjected to administration of the administration device 100 will be described.

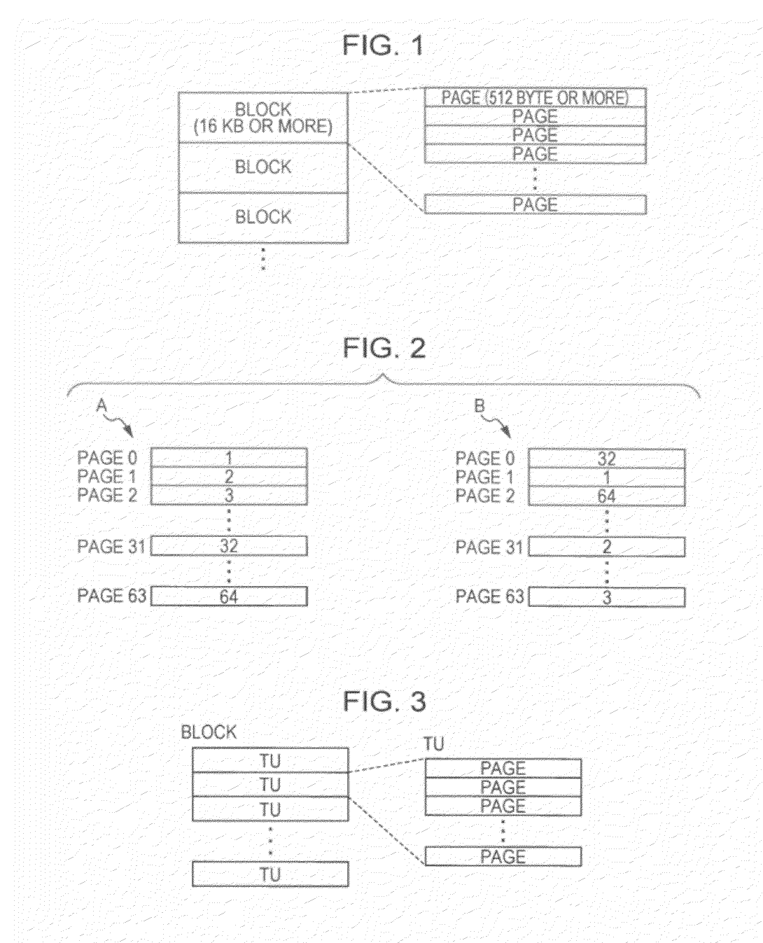

FIGS. 1 and 2 are explanatory diagrams illustrating the premise in the nonvolatile memory. As shown in FIG. 1, the nonvolatile memory is configured such that the minimum unit of reading/writing of data is a “page”, and the minimum unit of erasing is a “block” which is formed of a plurality of pages.

Further, in the nonvolatile memory, there are blocks (unavailable blocks), in which data is not recordable, called “defective blocks” at the time of manufacture and the like. Hence, the administration device 100 has to read/write data without using the defective blocks in the nonvolatile memory.

Furthermore, in each block of the nonvolatile memory, numbers (numbers for identifying pages) are assigned to the pages contained in each block. Thus, in most of the nonvolatile memories such as the NAND flash memory, as shown in A of FIG. 2, data is written in ascending order of the corresponding numbers. In addition, in most of the nonvolatile memories such as the NAND flash memory, for example, as shown in B of FIG. 2, writing data in pages in random order is prohibited.

Further, in each block of the nonvolatile memory, there is a limitation (so-called lifetime) on the number of rewriting operations. Thus, in order to increase the lifetime of the nonvolatile memory, it is necessary to prevent the rewriting operations from being biased to specific blocks.

The nonvolatile memory may have, for example, the above-mentioned characteristics. In this case, in order not to cause inconvenience to a user, it is preferable to prevent the user from being aware of, for example, the defective blocks or the processing of erasing. Hence, the administration of the nonvolatile memory uses, for example, a logical-physical translation layer that analyzes the request from the system (for example, a file system) using the nonvolatile memory and translates the request into a command for an operation of the nonvolatile memory such as a writing operation or a reading operation.

Problems in Related Art

Next, problems in the related art will be described in further detail. FIGS. 3 to 6H are explanatory diagrams illustrating the problems in the related art.

As described above, in the related art, the logical-address-to-physical-address translation is performed in the translation units (hereinafter referred to as “TU”) each of which is a unit smaller than the size of a block. Here, as shown in FIG. 3, the translation unit has a size equal to 1/n of the block size where n is an integer and a size equal to an integer multiple of the page size. That is, the block includes a plurality of translation units, and each translation unit includes a plurality of pages.

Further, in the related art, the translation unit is classified into the following two categories: an actual translation unit (hereinafter referred to as a “physical translation unit” or a “physical TU”) in the nonvolatile memory; and a translation unit (hereinafter referred to as a “logical translation unit”, “logical TU”, or “LTU”) which is subjected to the address translation and is provided to the system using the nonvolatile memory. With such a configuration, in the related art, it is possible to flexibly set the size of data for reading/writing, for example, it is possible to make the unit of the reading/writing in the file system coincide with the translation unit.

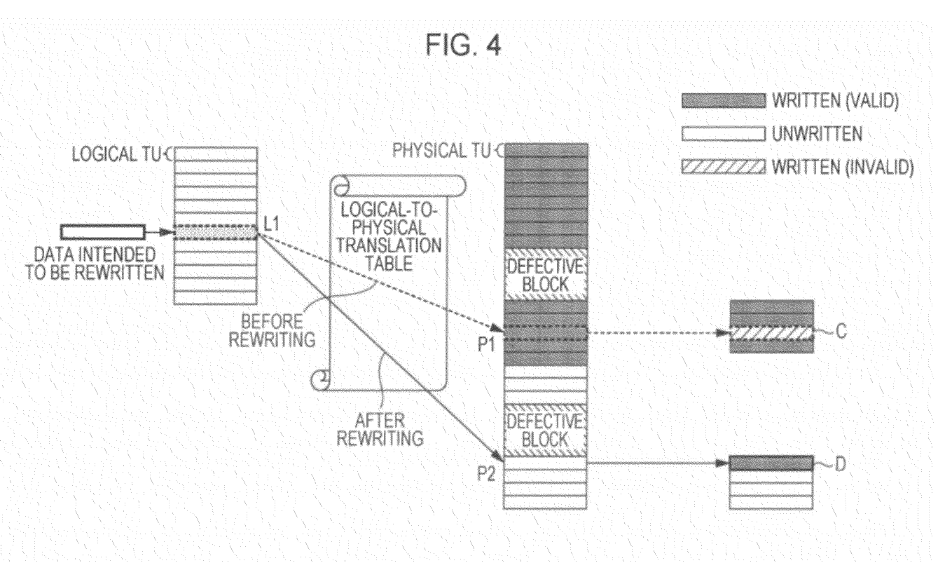

Furthermore, in the related art, as shown in FIG. 4, data is rewritten by additionally recording the data in the physical translation unit in which data is not recorded. More specifically, the physical translation unit P1, in which the data before the rewriting was recorded, is updated to become invalid (C of FIG. 4), and new data to be rewritten is written in the physical translation unit P2 in which data is not recorded (D of FIG. 4), thereby performing the rewriting of data. In such a manner, in the nonvolatile memory, as shown in the physical translation unit P2 of FIG. 4, there is the physical translation unit (hereinafter referred to as a “written valid physical translation unit”) in a state where latest data is being recorded and the physical translation unit (hereinafter referred to as a “written invalid physical translation unit”) in a state where old data as the erasing target is being recorded.

In the following description, in the physical translation unit, a state, in which the latest data is recorded, is referred to as “INUSE”, and a state, in which the old data as the erasing target is recorded, is referred to as “DIRTY”. Further, in the following description, a physical translation unit, in which data is not recorded, is referred to as an “unwritten physical translation unit”, and a state, in which data is not recorded after the erasing (or at the beginning), in the physical translation unit is referred to as “CLEAN”.

As described above, the nonvolatile memory such as the NAND flash memory is able to erase data only on a block-by-block basis. Hence, even when the “written invalid physical translation unit” as represented by for example the physical translation unit P1 of FIG. 4 is present in some physical translation units constituting the block, the “written valid physical translation unit” may reside in the corresponding block. In this case, it is difficult to perform the erasing. Accordingly, as data is repeatedly written, the number of the “written invalid physical translation units” in the nonvolatile memory increases, and the number of the physical translation units (for example, the CLEAN physical translation units), in which data can be written, decreases. That is, as data is repeatedly written, the free space in the nonvolatile memory decreases.

Therefore, in the related art, in order to secure the free space in the nonvolatile memory by increasing the number of the physical translation units in which data can be written, fold processing is performed. Here, the fold processing is defined as processing of increasing unwritten physical translation units by the number of written invalid physical translation units, which are contained in a block of a copy source, by copying data of written valid physical translation units among the contents of the block into a block, in which the unwritten physical translation units reside, and by erasing the block of the copy source.

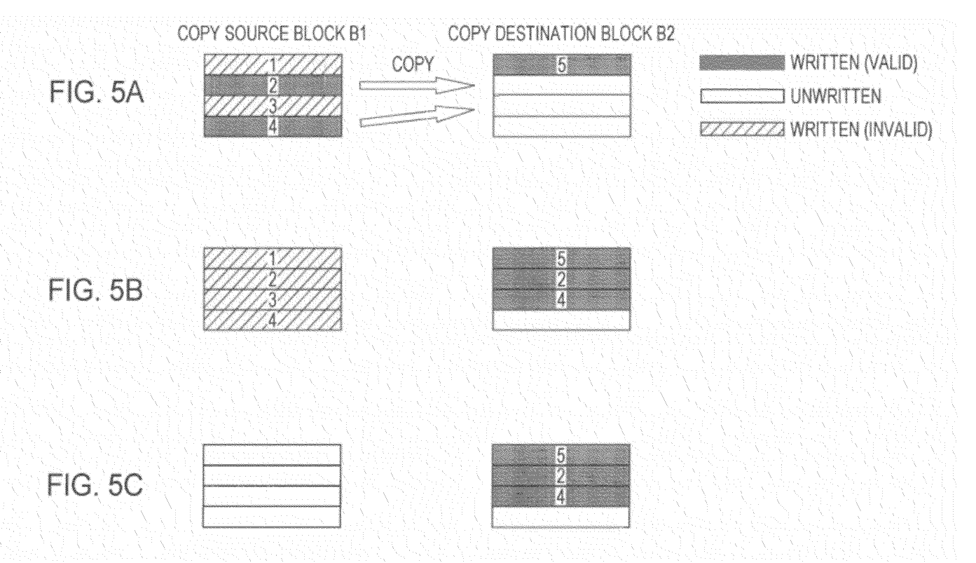

FIGS. 5A to 5C show a brief overview of the fold processing. FIG. 5A shows states of the blocks B1 and B2 before the fold processing, and FIG. 5B shows states of the blocks B1 and B2 during the fold processing. In addition, FIG. 5C shows states of the blocks B1 and B2 after the fold processing. In the fold processing, the “written valid physical translation units” of the copy source block B1 are copied to the copy destination block B2, and the copied physical translation units are updated into the “written invalid physical translation units” (FIG. 5B). Then, in the fold processing, the copy source block B1 is erased (FIG. 5C). As shown in FIGS. 5A to 5C, it can be observed that the number of the “unwritten physical translation units” increases through the fold processing. Accordingly, through the fold processing, it is possible to increase the free space in the nonvolatile memory.

In the related art, for example, after data of the nonvolatile memory is written, when the total number of the blocks (blocks which include INUSE or DIRTY physical translation units, and which are hereinafter referred to as “in-use blocks”), in which data is recorded, exceeds a threshold value (or is equal to or greater than the threshold value), the fold processing is performed once. Accordingly, in the case of using the related art, it is possible to increase the free space in the nonvolatile memory. However, in the related art, there is no consideration for an increase of efficiency in securing the free space, and thus it is difficult to efficiently secure the free space of the nonvolatile memory.

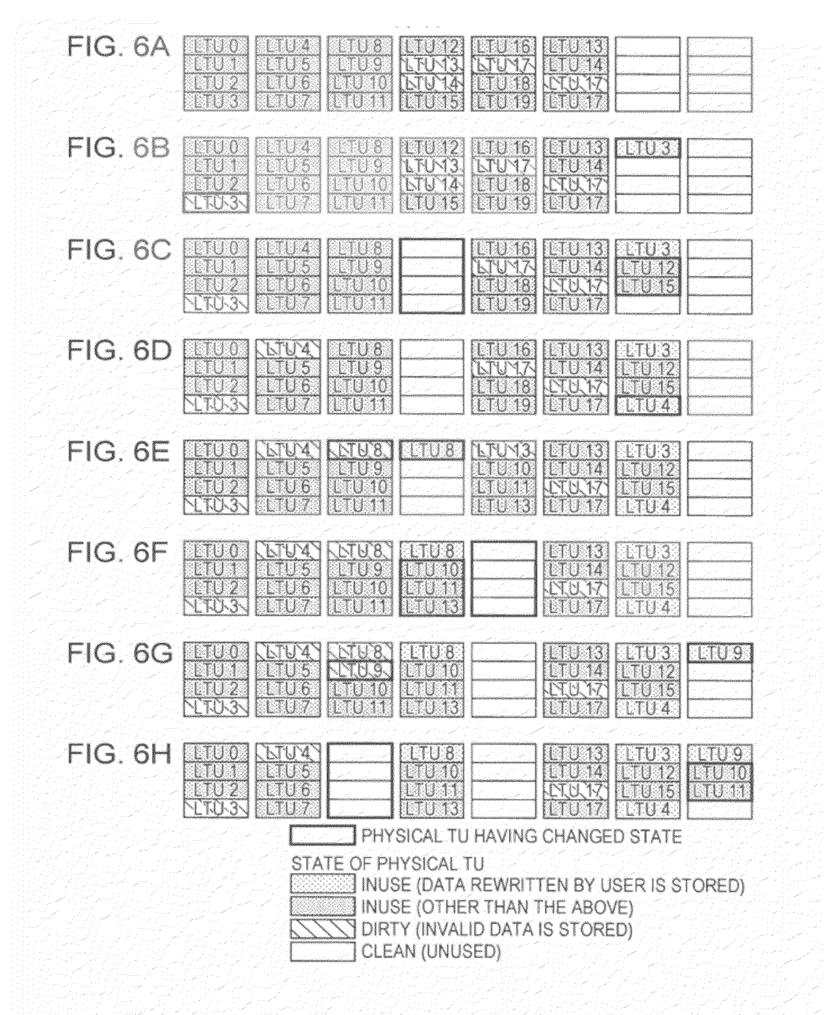

FIGS. 6A to 6H show an example of the fold processing according to the related art, and show the respective states of blocks of the nonvolatile memory in chronological order. Here, FIGS. 6A to 6H show a case where the fold processing is performed when the number of in-use blocks is greater than 6 (an example of the threshold value) (an initiation condition), and the fold processing is terminated when the processing is performed once (a stopping condition). In the following description, the administration device (hereinafter referred to as an “existing administration device 10”) according to the related art performs the processing shown in FIGS. 6A to 6H.

In the state of FIG. 6A, when the LTU 3 is rewritten (FIG. 6B), the initiation condition is satisfied, and thus the existing administration device 10 performs the fold processing (FIG. 6C). Since the stopping condition is satisfied by performing the fold processing, the existing administration device 10 does not perform the fold processing until the initiation condition is satisfied again.

Further, in the state of FIG. 6C, when the LTU 4 is written (FIG. 6D), the existing administration device 10 determines whether or not the initiation condition is satisfied. In the state of FIG. 6D, the initiation condition is not satisfied, and thus the existing administration device 10 does not perform the fold processing.

In the state of FIG. 6D, when the LTU 8 is rewritten (FIG. 6E), the initiation condition is satisfied, and thus the existing administration device 10 performs the fold processing (FIG. 6F). Since the stopping condition is satisfied by performing the fold processing, the existing administration device 10 does not perform the fold processing until the initiation condition is satisfied again.

Then, in the state of FIG. 6F, when the LTU 9 is rewritten (FIG. 6G), the initiation condition is satisfied, and thus the existing administration device 10 performs the fold processing (FIG. 6H). Since the stopping condition is satisfied by performing the fold processing, the existing administration device 10 does not perform the fold processing until the initiation condition is satisfied again.

As shown in FIGS. 6A to 6H, the existing administration device 10 performs the fold processing once whenever the initiation condition is satisfied. From the result, as shown in FIG. 6H, the rewritten LTU 3, LTU 4, LTU 8, and LTU 9 are written to be distributed in the plurality of blocks. Here, the system using the nonvolatile memory may be for example a file system such as the FAT (File Allocation Table) system. In this case, when the rewriting is performed in an access pattern (the rewriting sequence) of certain logical translation units, there is a high possibility that the rewriting will be performed in the same access pattern as the corresponding access pattern in the future. Further, for example, in such a case where the size of the logical translation unit is equal to the size of the cluster of FAT, the possibility further increases. Further, the file system according to the embodiment of the disclosure is not limited to FAT, and for example, may be NTFS (NT File System), ext4 (fourth extended file system) or the like.

Here, for example, data may be rewritten in the nonvolatile memory in the same access pattern as the access pattern of the logical translation unit shown in FIGS. 6A to 6H. In this case, the physical translation units corresponding to the LTU 3, the LTU 4, the LTU 8, and the LTU 9 shown in FIG. 6H are converted into the “written invalid physical translation units”.

However, as shown in FIG. 6H, the LTU 3, the LTU 4, the LTU 8, and the LTU 9 are being written to be distributed in the plurality of blocks. Therefore, it is difficult to expect that the block including a lot of “written invalid physical translation units” resides in the nonvolatile memory. Accordingly, even when the fold processing is performed in a state where the block including a lot of “written invalid physical translation units” does not reside, it is difficult to sufficiently secure the free space of the nonvolatile memory. Hence, even when the related art is used, it is difficult to say that it is possible to efficiently secure the free space of the nonvolatile memory.

Brief Overview of Administration Method According to Embodiment of the Disclosure

Similarly to the related art, the administration device 100 according to the embodiment of the disclosure administers writing, reading, and erasing of data in the nonvolatile memory by translating a logical address into a physical address on a per-translation-unit basis.

Further, similarly to the related art, the administration device 100 secures the free space of the nonvolatile memory by performing the fold processing. However, in the related art, the administration device 100 performs the fold processing once, while the fold processing is repeatedly performed until the prescribed stopping condition is satisfied, thereby increasing efficiency in securing the free space in the nonvolatile memory. In the following description, regarding the fold processing according to the embodiment of the disclosure, the fold processing, which can be repeatedly performed, is referred to as a “multi-fold processing”. Here, the prescribed stopping condition according to the embodiment of the disclosure is, for example, as follows: “the size of the unwritten physical translation units increased through the fold processing is equal to or greater than the block size”; or “the size of the unwritten physical translation units increased through the fold processing is equal to or greater than a predetermined integer multiple of the block size”.

Further, when initiating the fold processing, the administration device 100 copies the data of the written valid physical translation units into the block in which the first physical translation unit is unwritten among the blocks in which the unwritten physical translation units reside.

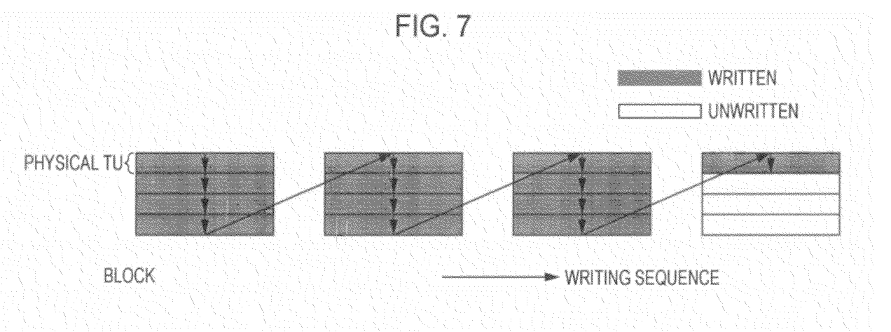

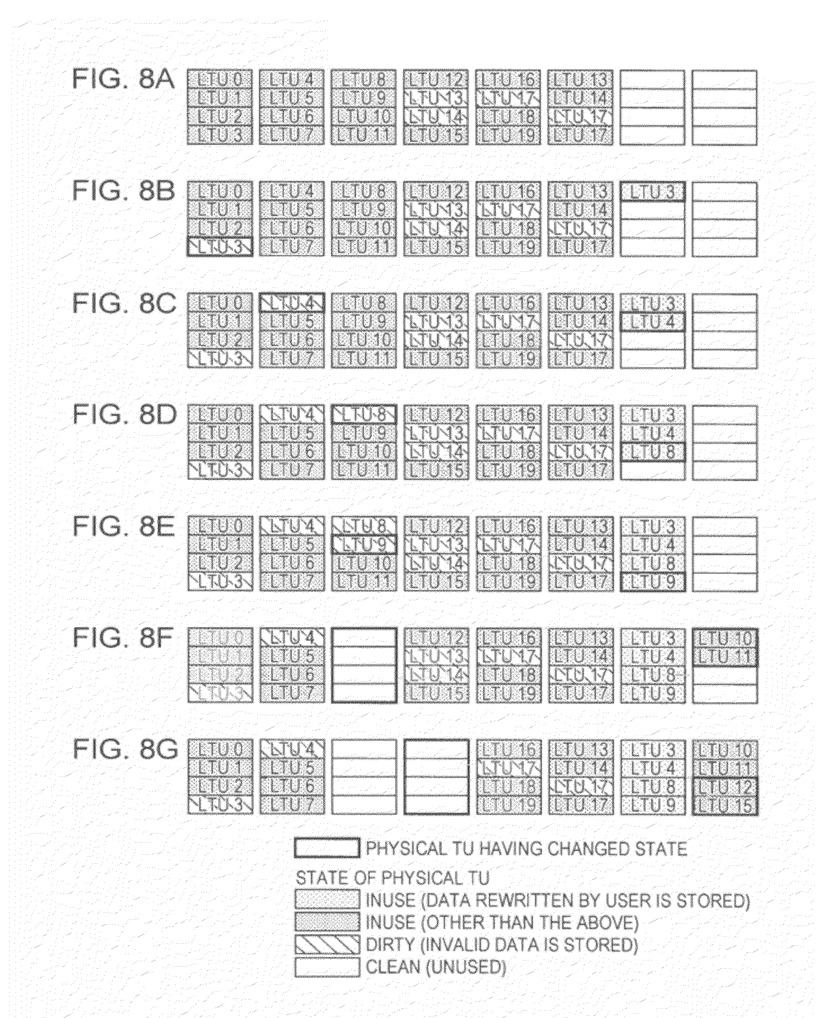

FIG. 7 is an explanatory diagram illustrating the sequence of writing the data in the nonvolatile memory when fold processing is initiated by the administration device 100 according to the embodiment of the disclosure. The administration device 100 selects the blocks in which data is not recorded, and writes data in order from the first physical translation unit (the physical translation unit of which the assigned number is smallest) in the corresponding block. Then, when completely writing all the physical translation units constituting blocks as writing targets (hereinafter referred to as a “writing target block” or a “PTU block”) in which data is being written, the administration device 100 newly selects the blocks in which data is not recorded, and writes data in the corresponding block. In the following description, the physical translation unit as a target of the writing of data is referred to as “PTU”. Further, in the following description, the physical translation unit, which is being subjected to the writing of data at each time point in which the writing of data is performed, is referred to as a “current writing target physical translation unit” or a “writing target PTU”. That is, the writing target block according to the embodiment of the disclosure is defined as a block including the current writing target physical translation unit.

More specifically, the administration device 100 performs, for example, the following processing of (1) (the processing of determining the initiation condition) and processing of (2) (the fold processing), thereby increasing the efficiency in securing the free space in the nonvolatile memory.

(1) Processing of Determining Initiation Condition

The administration device 100 determines whether or not the initiation condition for initiating the fold processing is satisfied.

Here, the initiation conditions according to the embodiment of the disclosure is, for example, as follows: the write location, at which data is most recently written, is the last physical translation unit in the block; and the number of blocks, in which data is being written, is greater than a predetermined threshold value (or not less than the predetermined threshold value; the rest is the same as above). As one of the initiation conditions, by setting a condition in which the write location of the most recently written data is the last physical translation unit in the block, as shown in FIG. 7, the administration device 100 is able to copy the data of the “written valid physical translation unit” to the first physical translation unit of the block. Further, as one of the initiation conditions, by setting a condition in which the number of blocks of data being written is greater than a predetermined threshold value, the administration device 100 is able to secure the free space when the free space of the nonvolatile memory is less than a certain value (or not more than the certain value).

Further, in the administration device 100, the initiation conditions may be set as follows: the write location, at which data is most recently written, is the last physical translation unit in the block; and the number of blocks, in which data is not written, is less than the predetermined threshold value (or not more than the predetermined threshold value; the rest is the same as above). As one of the initiation conditions, by setting a condition in which the number of blocks not containing written data is less than the predetermined threshold value, for example, even when the absolute volume in which data is recordable decreases as a result of an increase in defective blocks in the nonvolatile memory, it is possible to secure the free space.

Further, the initiation conditions according to the embodiment of the disclosure are not limited to the above description. For example, in the administration device 100, a condition, in which both of the two initiation conditions are combined, (the logical addition of the two initiation conditions) can be set as the initiation condition. Further, the administration device 100 may further add, to the above-mentioned respective initiation conditions, a condition in which the writing, reading, and erasing of data are not performed in the nonvolatile memory (in other words, the system is in a so-called idle state). As one of the initiation conditions, by setting a condition in which the data is not written, read, and erased in the nonvolatile memory, the administration device 100 is able to prevent the processing of writing, reading, and erasing data and the fold processing from being performed at the same time. Accordingly, from the viewpoint of a user, the administration device 100 is able to achieve improvement in performance of data rewriting and the like in the nonvolatile memory.

(2) Fold Processing

If it is determined through the processing of (1) (the processing of determining the initiation condition) that the initiation condition is satisfied, the administration device 100 repeats the fold processing, for example until, the size (the total size) of the unwritten physical translation units increased through the fold processing is equal to or greater than a predetermined size based on the block size (multi-fold processing).

Here, there is an example of the stopping condition of the processing of (2) (the fold processing) that “the size (the total size) of the unwritten physical translation units increased through the fold processing is equal to or greater than a predetermined size based on the block size”. Further, examples of the predetermined size based on the block size according to the embodiment of the disclosure include the block size or the size equal to the integer multiple of the block size. The predetermined size based on the block size according to the embodiment of the disclosure may be, for example, a size which is prescribed in advance, and a size which is appropriately set on the basis of a user operation. Furthermore, the size according to the embodiment of the disclosure is represented by for example [Byte] and [KByte], but the size according to the embodiment of the disclosure is not limited to the above.

Further, after performing the fold processing, the administration device 100 may determine whether or not the size of the “unwritten physical translation units” increased through the fold processing is divisible by the block size. In the case of performing the determination, if it is determined that the size is indivisible, the administration device 100 copies the data of the written valid physical translation units through the fold processing by the size of the unwritten physical translation units corresponding to the size of the fraction thereof. The administration device 100 selectively copies the data of the “written valid physical translation units” on the basis of the result of the determination result, whereby in the nonvolatile memory after the processing of (2) (the fold processing), the write location, at which data is most recently written, is made to be the last physical translation unit in the block. Accordingly, by selectively copying the data of the “written valid physical translation units” on the basis of the result of the determination result, the data rewritten by a user and data copied by the fold processing can be divided between the blocks. From the result, the access pattern of the user is stored in the block. Accordingly, by selectively copying the data of the “written valid physical translation units” on the basis of the result of the determination result, it is possible to further efficiently secure the free space.

The administration device 100 repeats the fold processing until the stopping condition is satisfied as described above. Here, the fold processing in the administration device 100 according to the embodiment of the disclosure will be described. The administration device 100 performs, as the fold processing, processing of increasing the “unwritten physical translation units” by the number of the “written invalid physical translation units”, which are contained in the block of the copy source, by copying data of the “written valid physical translation units” among the contents of the block into a block, in which the “unwritten physical translation units” reside, and by erasing the block of the copy source. That is, the administration device 100 performs, as the fold processing, processing basically the same as that of the related art.

Further, the administration device 100 selects, as the copy source block in the fold processing, for example the block, in which the number of the “written invalid physical translation units” among the blocks in the nonvolatile memory is greater. As described above, by selecting the copy source block in the fold processing, it is possible to further increase the number of the “written invalid physical translation units” increasing after the fold processing. Therefore, the administration device 100 is able to further efficiently secure the free space of the nonvolatile memory.

Further, the method of selecting the block in the administration device 100 is not limited to the above-mentioned method. For example, when performing the fold processing, the administration device 100 may exclude the block including the physical translation unit, which corresponded to the logical translation unit containing the most recently written data before the most recent writing, from the fold processing targets. The administration device 100 excludes the specific block as described above, and then performs the block selection, whereby it is possible to further efficiently secure the free space of the nonvolatile memory. Further, the effect in the case of using the selection method will be described later.

Further, for example, when a plurality of blocks having the largest number of the “written invalid physical translation units” reside in the nonvolatile memory, the administration device 100 may randomly select a block among the corresponding blocks. As described above, by randomly selecting a block, it is possible to increase the lifetime of the nonvolatile memory in addition to efficiently securing the free space of the nonvolatile memory.

The administration device 100 selects, for example, the copy source block in the fold processing as described above, thereby efficiently securing the free space of the nonvolatile memory.

Further, in the administration device 100, in the case of performing the fold processing, the sequence, in which data pieces of the “written valid physical translation units” are copied, is, for example, as described in the following items (a) to (c).

(a) First Sequence

The administration device 100 copies the data of the “written valid physical translation units” within the block in ascending order of the numbers which are respectively assigned to the physical translation units. That is, the administration device 100 copies the data in order from the first “written valid physical translation unit” of the block. By using the first sequence, for example, it is possible to keep the writing order of the old logical translation units.

(b) Second Sequence

The administration device 100 copies the data of the “written valid physical translation units” within the block in ascending order of the numbers which are respectively assigned to the logical translation units corresponding thereto. More specifically, the administration device 100 sorts the data in ascending order of the numbers which are respectively assigned to the corresponding logical translation units, and copies the “written valid physical translation units” corresponding to the logical translation units in the sorted sequence. Here, for example, in the FAT file system, allocation of empty clusters is performed in ascending order of cluster numbers. Accordingly, for example, when the cluster numbers coincide with the numbers assigned to the logical translation units, it is possible to increase the possibility that the administration device 100 is able to allocate the clusters of the same file to the same block of the nonvolatile memory.

(c) Third Sequence

The administration device 100 specifies the “written valid physical translation units” in all the blocks as the copy sources in the fold processing (the multi-fold processing) repeatedly performed. Here, the administration device 100 performs the specification, for example, by virtually performing the multi-fold processing. Then, the administration device 100 copies the data of the specified physical translation units in ascending order of the numbers which are respectively assigned to the logical translation unit respectively corresponding to the specified physical translation units. By using the third sequence, as compared with the case of performing the copy operation in the second sequence, it is possible to further increase the possibility that the administration device 100 is able to allocate the clusters of the same file to the same block of the nonvolatile memory.

For example, the administration device 100 copies the data of the “written valid physical translation units” through the sequences shown in (a) to (c). Further, the sequence, in which the data pieces of the “written valid physical translation units” according to the embodiment of the disclosure are copied, is not limited to the above description. For example, the administration device 100 may copy the data of the “written valid physical translation units” in an arbitrary sequence.

The administration device 100 repeatedly performs, for example, the above-mentioned fold processing (performing the multi-fold processing) as the processing of (2) (the fold processing) until the stopping condition is satisfied, thereby securing the free space of the nonvolatile memory.

The administration device 100 performs, for example, the processing of (1) (the processing of determining the initiation condition) and the processing of (2) (the fold processing), thereby increasing the efficiency in securing the free space in the nonvolatile memory. Further, in the above description, the administration device 100 performs the processing of (1) (the processing of determining the initiation condition), and thereafter performs processing of (2) (the fold processing), but the processing in the administration device 100 is not limited to the above. For example, the administration device 100 may perform the processing of (2) (fold processing) regardless of the result of the processing of (1) (the processing of determining the initiation condition). For example, the processing of (2) (multi-fold processing) may be performed on the basis of the operation signal, which is transferred from the operation section (to be described later) provided in the administration device 100, or the external operation signal which is transmitted from an external operation device (not shown in the drawing) such as a remote controller in response to the user operation.

Next, the effect of the multi-fold processing performed by the administration device 100 will be described. FIGS. 8A to 8G are explanatory diagrams illustrating an example of the multi-fold processing in the administration device 100 according to the embodiment of the disclosure. Here, similarly to FIGS. 6A to 6H, FIGS. 8A to 8G show the respective states of blocks of the nonvolatile memory in chronological order. Further, FIGS. 8A to 8G show the case where the initiation condition of the multi-fold processing is the write location, at which data is most recently written, is the last physical translation unit in the block, and the number of blocks (in-use blocks), in which data is being written, is equal to or greater than 7 (an example of the predetermined threshold value). Further, FIGS. 8A to 8G show the case of setting, as the stopping condition of the multi-fold processing, a condition in which the size of the “unwritten physical translation units” increased through the fold processing is equal to or greater than the block size.

In the state of FIG. 8A, when the LTU 3 is rewritten (FIG. 8B), the administration device 100 determines whether or not the initiation condition is satisfied. In the state of FIG. 8B, the initiation condition is not satisfied, and thus the administration device 100 does not perform the fold processing.

In the state of FIG. 8B, when the LTU 4 is rewritten (FIG. 8C), the administration device 100 determines whether or not the initiation condition is satisfied. In the state of FIG. 8C, the initiation condition is not satisfied, and thus the administration device 100 does not perform the fold processing.

In the state of FIG. 8C, when the LTU 8 is rewritten (FIG. 8D), the administration device 100 determines whether or not the initiation condition is satisfied. In the state of FIG. 8D, the initiation condition is not satisfied, and thus the administration device 100 does not perform the fold processing.

In the state of FIG. 8D, when the LTU 9 is rewritten (FIG. 8E), the administration device 100 determines whether or not the initiation condition is satisfied. Since the initiation condition is satisfied by rewriting the LTU 9, the administration device 100 performs the first fold processing (FIG. 8F).

When performing the fold processing, the administration device 100 determines whether or not the stopping condition is satisfied. In the state of FIG. 8F, the stopping condition is not satisfied, and thus the administration device 100 performs the second fold processing (FIG. 8G). Then, the administration device 100 determines whether or not the stopping condition is satisfied.

In the state of FIG. 8G, the number of “unwritten physical translation units” increases by the size corresponding to size of a single block, and thus the stopping condition is satisfied. Accordingly, the administration device 100 terminates the multi-fold processing.

Here, it can be seen from FIG. 8G that, by performing the multi-fold processing, the rewritten LTU 3, LTU 4, LTU 8, and LTU 9 are collected in the same block. Here, when the rewriting is performed in the same access pattern of the logical translation units in the future, the physical translation units contained in the block subjected to the rewriting are converted into the “written invalid physical translation units”. Accordingly, as compared with the fold processing according to the related art shown in FIGS. 6A to 6H, the administration device 100 is able to further efficiently secure the free space of the nonvolatile memory. Further, in the example shown in FIGS. 8A to 8G, when the rewriting is performed in the same access pattern of the logical translation units in the future, the administration device 100 has only to erase the block in which the rewriting is performed. Hence, from the viewpoint of a user, it is possible to achieve improvement in performance of data rewriting and the like in the nonvolatile memory.

The administration device 100 performs, for example, the multi-fold processing shown in FIGS. 8A to 8G, whereby it is possible to increase efficiency in securing the free space in the nonvolatile memory.

Further, the multi-fold processing in the administration device 100 according to the embodiment of the disclosure is not limited to the example shown in FIGS. 8A to 8G. For example, in FIGS. 8A to 8G, when the stopping condition of the multi-fold processing is satisfied, the size of the “unwritten physical translation units” coincides with the block size, but may exceed the corresponding block size. Therefore, next, as another example of the multi-fold processing in the administration device 100 according to the embodiment of the disclosure, the following case will be described: when the stopping condition of the multi-fold processing is satisfied, the increased size of the “unwritten physical translation units” exceeds the block size.

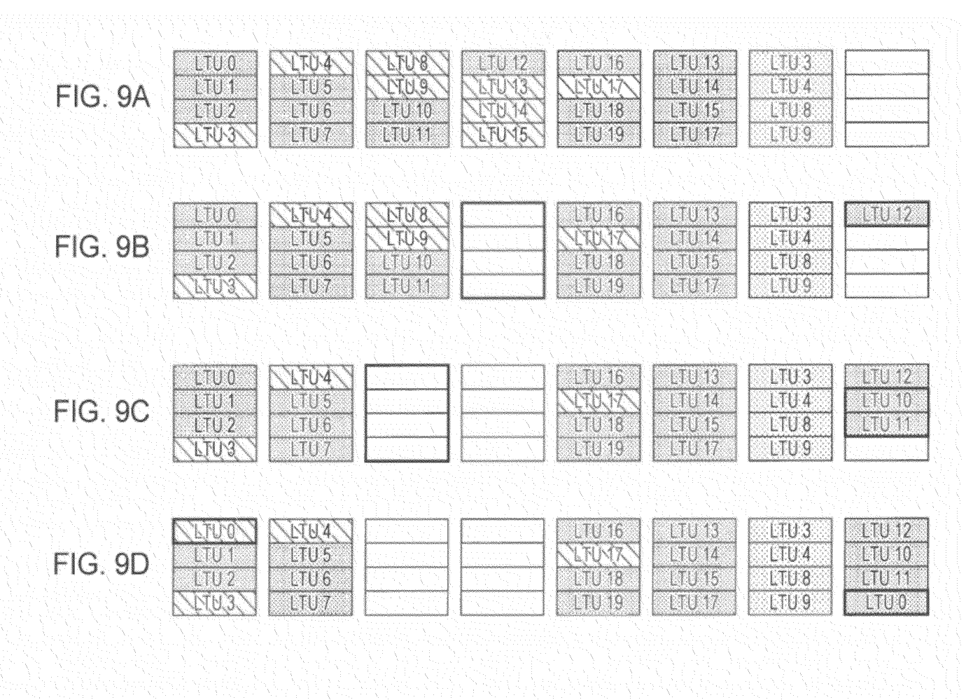

FIGS. 9A to 9D are explanatory diagrams illustrating another example of the multi-fold processing in the administration device 100 according to the embodiment of the disclosure. Here, FIGS. 9A to 9D show the case where, when the stopping condition of the multi-fold processing is satisfied, the increased size of the “unwritten physical translation units” exceeds the block size. Further, similarly to FIGS. 8A to 8G, FIGS. 9A to 9D show the respective states of blocks of the nonvolatile memory in chronological order. Furthermore, FIGS. 9A to 9D show an example in which the administration device 100 performs the fold processing under the initiation condition and the stopping condition the same as the conditions of FIGS. 8A to 8G.

In the state of FIG. 9A, when the LTU 12 is rewritten (FIG. 9B), the administration device 100 determines whether or not the initiation condition is satisfied. Since the initiation condition is satisfied by rewriting the LTU 12, the administration device 100 performs the first fold processing (FIG. 9B).

When performing the fold processing, the administration device 100 determines whether or not the stopping condition is satisfied. In the state of FIG. 9B, the stopping condition is not satisfied, and thus the administration device 100 performs the second fold processing (FIG. 9C). Then, the administration device 100 determines whether or not the stopping condition is satisfied.

In the state of FIG. 9C, the “unwritten physical translation units” increases as the size thereof becomes greater than the size of a single block, and thus the stopping condition is satisfied. Further, in the state of FIG. 9C, contrary to the state of FIG. 8G, the size of the “unwritten physical translation units” increased through the fold processing is indivisible by the block size. In the above case, the administration device 100 copies the data of the LTU 0 as the written valid physical translation unit through the fold processing by the size (in the example of FIG. 9C, the size of a single physical translation unit) of the unwritten physical translation unit corresponding to the size of the fraction thereof (FIG. 9D).

As shown in FIG. 9D, the size exceeding the size (an example of the predetermined size based on the block size) of the single block is filled with the data of the “written valid physical translation unit”, whereby the nonvolatile memory state after the multi-fold processing is changed to the state shown in FIG. 8G. Accordingly, also in the case of performing the processing shown in FIGS. 9A to 9D, similarly to the multi-fold processing shown in FIGS. 8A to 8G, the administration device 100 is able to increase efficiency in securing the free space in the nonvolatile memory. Further, the administration device 100 has only to erase the block in which the rewriting is performed in the fold processing to be performed in the future. Hence, similarly to the multi-fold processing shown in FIGS. 8A to 8G, from the viewpoint of a user, it is possible to achieve improvement in performance of data rewriting and the like in the nonvolatile memory.

Further, the multi-fold processing in the administration device 100 according to the embodiment of the disclosure is not limited to the examples shown in FIGS. 8A to 8G and FIGS. 9A to 9D. For example, when further performing the fold processing, the administration device 100 is able to perform the multi-fold processing under the stopping condition in which the size of the “unwritten physical translation units” exceeds the predetermined size based on the block size.

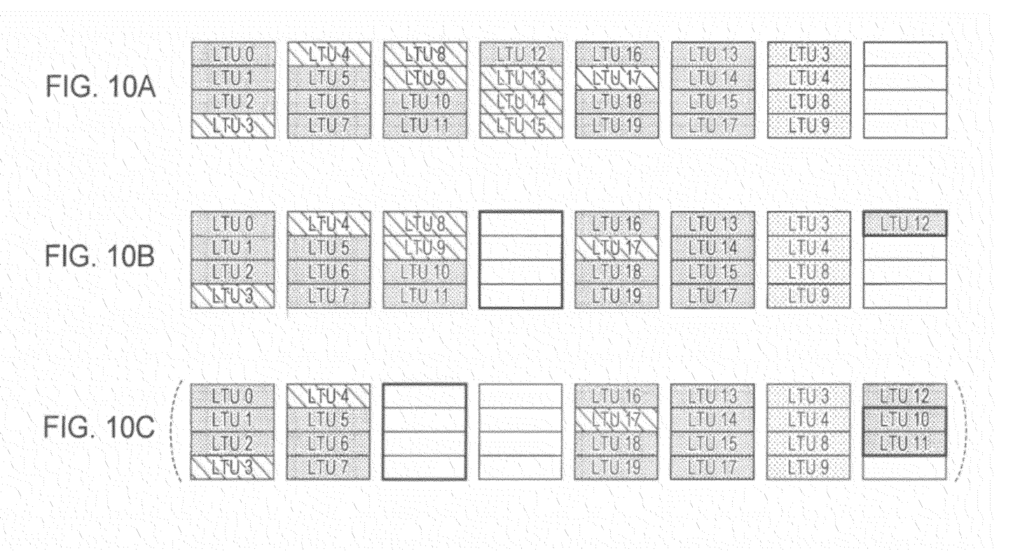

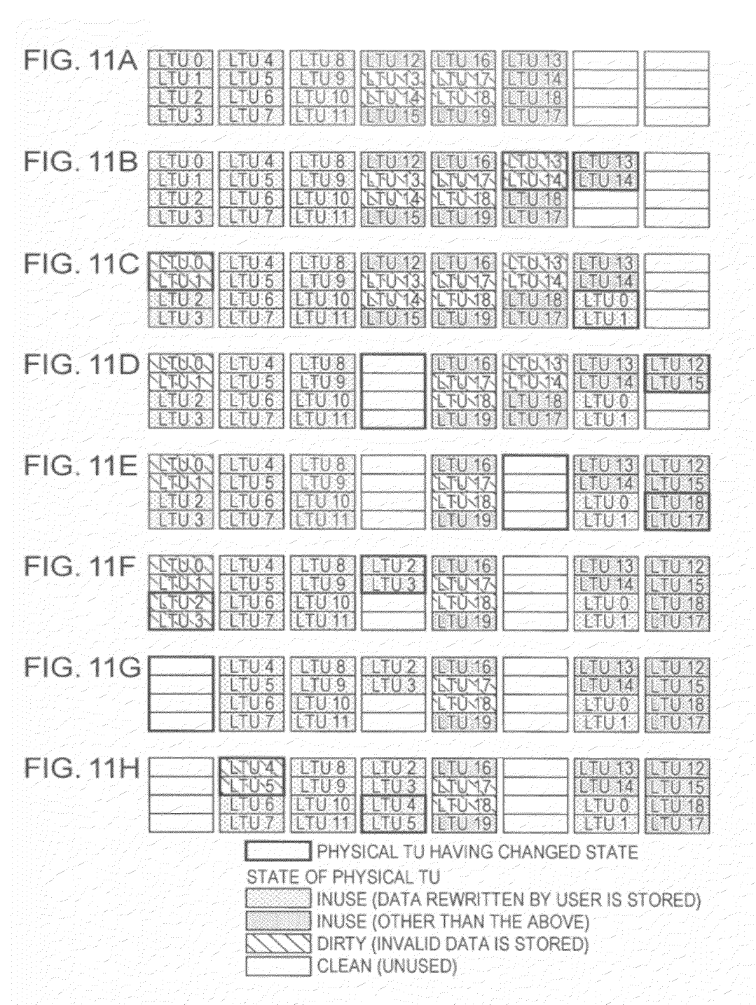

FIGS. 10A to 10C are explanatory diagrams illustrating another example of the multi-fold processing in the administration device 100 according to the embodiment of the disclosure. Further, similarly to FIGS. 8A to 8G and 10A to 100 show the respective states of blocks of the nonvolatile memory in chronological order. Further, FIGS. 10A to 10C show an example in which the administration device 100 performs the fold processing under the same initiation condition as the condition of FIGS. 8A to 8G.

In the state of FIG. 10A, when the LTU 12 is rewritten (FIG. 10B), the administration device 100 determines whether or not the initiation condition is satisfied. Since the initiation condition is satisfied by rewriting the LTU 12, the administration device 100 performs the first fold processing (FIG. 10B).

When performing the fold processing, in the case of further performing the fold processing, the administration device 100 determines whether or not the increased size of the “unwritten physical translation units” exceeds the block size (determination of the stopping condition). Here, for example, by virtually performing the fold processing, the administration device 100 performs the determination. Here, in the state of FIG. 10B, when the second fold processing is performed, the increased size of the “unwritten physical translation units” exceeds the block size (FIG. 100). Accordingly, the administration device 100 terminates the multi-fold processing without performing the second fold processing when the nonvolatile memory is in the state of FIG. 10B.

The administration device 100 performs the multi-fold processing under the above-mentioned stopping condition, whereby it is possible to prevent the subsequently rewritable data from being segmented. Accordingly, the administration device 100 performs the multi-fold processing under the above-mentioned stopping condition, whereby from the viewpoint of a user, it is possible to achieve improvement in performance of data rewriting and the like in the nonvolatile memory.

In addition, the multi-fold processing in the administration device 100 according to the embodiment of the disclosure is not limited to the example shown in FIGS. 8A to 100. For example, as described above, when performing the fold processing, the administration device 100 may exclude the block including the physical translation unit, which corresponded to the logical translation unit containing the most recently written data before the most recent writing, from the fold processing targets.

FIGS. 11A to 11H are explanatory diagrams illustrating another example of the multi-fold processing in the administration device according to the embodiment of the disclosure. Here, FIGS. 11A to 11H show an example of the processing in a case where the specific block is excluded and then a block is selected. Further, similarly to FIGS. 8A to 8G and 11A to 11H show the respective states of blocks of the nonvolatile memory in chronological order. Furthermore, FIGS. 11A to 11H show an example in which the administration device 100 performs the fold processing under the same initiation conditions and the same stopping conditions as the conditions of FIGS. 8A to 8G. In addition, FIGS. 11A to 11H show the example of the processing in the case of: (i) writing of the LTU 0 to the LTU 11; (ii) interrupt of writing of the LTU 13 and the LTU 14; and (iii) overwriting of the LTU 0 to the LTU 11.

FIG. 11A shows the nonvolatile memory state immediately after the LTU 0 to the LTU 11 are written (immediately after (i)). Further, FIG. 11B shows the nonvolatile memory state immediately after the LTU 13 and the LTU 14 are written in the state of FIG. 11A (immediately after (ii)).

In the state of FIG. 11B, when the LTU 0 and the LTU 1 are written (FIG. 11C), the administration device 100 determines whether or not the initiation condition is satisfied. Since the initiation condition is satisfied by rewriting the LTU 0 and the LTU 1, the administration device 100 performs the first fold processing (FIG. 11D). At this time, the administration device 100 excludes the block (the block at the left end in FIGS. 11A to 11H) including the physical translation unit, which corresponded to the logical translation unit containing the most recently written data before the most recent writing, from the fold processing targets. FIG. 11D shows a case where the fourth block from the left end in FIGS. 11A to 11H is selected as the fold processing target.

When performing the first fold processing, the administration device 100 determines whether or not the stopping condition is satisfied. In the state of FIG. 11D, the stopping condition is not satisfied, and thus the administration device 100 performs the second fold processing (FIG. 11E). At this time, the administration device 100 excludes the block (the block at the left end in FIGS. 11A to 11H) including the physical translation unit, which corresponded to the logical translation unit containing the most recently written data before the most recent writing, from the fold processing targets. FIG. 11E shows a case where the sixth block from the left end in FIGS. 11A to 11H is selected as the fold processing target.

When performing the second fold processing, the administration device 100 determines whether or not the stopping condition is satisfied. In the state of FIG. 11E, the stopping condition is satisfied, and thus the administration device 100 terminates the multi-fold processing.

Subsequently, in the state of FIG. 11E, when the LTU 2 and the LTU 3 are written (FIG. 11F), the administration device 100 determines whether or not the initiation condition is satisfied. In the state of FIG. 11F, the initiation condition is not satisfied, and thus the administration device 100 does not perform the fold processing. Further, in the state shown in FIG. 11F, all the physical translation units, which are contained in the block at the left end in FIGS. 11A to 11H, are converted into the “written invalid physical translation units”. Therefore, the administration device 100 erases the block at the left end in FIGS. 11A to 11H (FIG. 11G).

Further, in the state of FIG. 11G, when the LTU 4 and the LTU 5 are written (FIG. 11H), the administration device 100 determines whether or not the initiation condition is satisfied. In the state of FIG. 11H, the initiation condition is not satisfied, and thus the administration device 100 does not perform the fold processing.

The administration device 100 also rewrites the LTU 6 to the LTU 11 similarly to FIGS. 11F to 11H. Here, as shown in FIGS. 11F to 11H, the administration device 100 performs erasing without performing the fold processing in the writing operations of the LTU 2 to the LTU 5, thereby performing rewriting. Accordingly, the administration device 100 excludes the block including the physical translation unit, which corresponded to the logical translation unit containing the most recently written data before the most recent writing, from the fold processing targets, whereby it is possible to increase efficiency in securing the free space of the nonvolatile memory, and it is also possible to further efficiently perform the rewriting of data.

Further, for example, in such a case of overwriting a file having a large size, rewriting is highly likely to be performed in the same access pattern as the old access pattern of the logical translation units. Accordingly, the administration device 100 excludes the block including the physical translation unit, which corresponded to the logical translation unit containing the most recently written data before the most recent writing, from the fold processing targets, whereby even in such a case of overwriting a file having a large size as described above, as shown in FIGS. 11A to 11H, it is possible to further efficiently perform the rewriting of data.

The administration device 100 performs, for example, the multi-fold processing shown in FIGS. 8A to 11H, whereby it is possible to increase efficiency in securing the free space in the nonvolatile memory. In addition, it is needless to say that the multi-fold processing in the administration device 100 according to the embodiment of the disclosure is not limited to the examples shown in FIGS. 8A to 11H.

Specific Example of Processing Relating to Administration Method According to Embodiment of the Disclosure

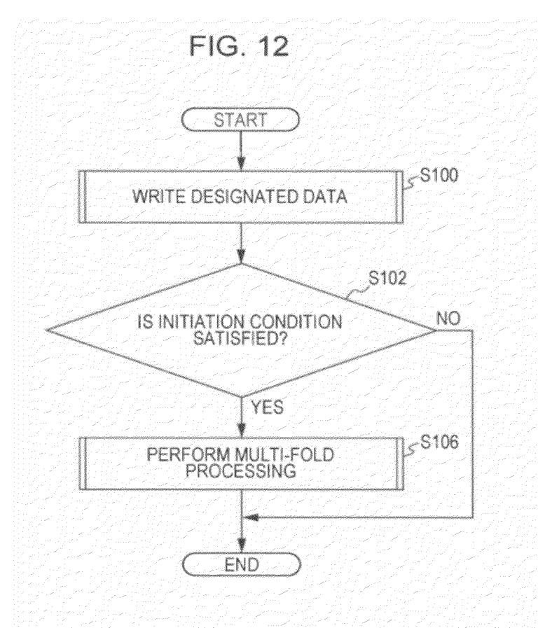

Next, the above-mentioned processing relating to the administration method according to the embodiment of the disclosure will be described in further detail. FIG. 12 is a flowchart illustrating an example of the processing relating to the administration method according to the embodiment of the disclosure. In the following description, the administration device 100 performs the processing relating to the administration method.

The administration device 100 writes designated data (S100: the writing processing).

Example of Writing Processing

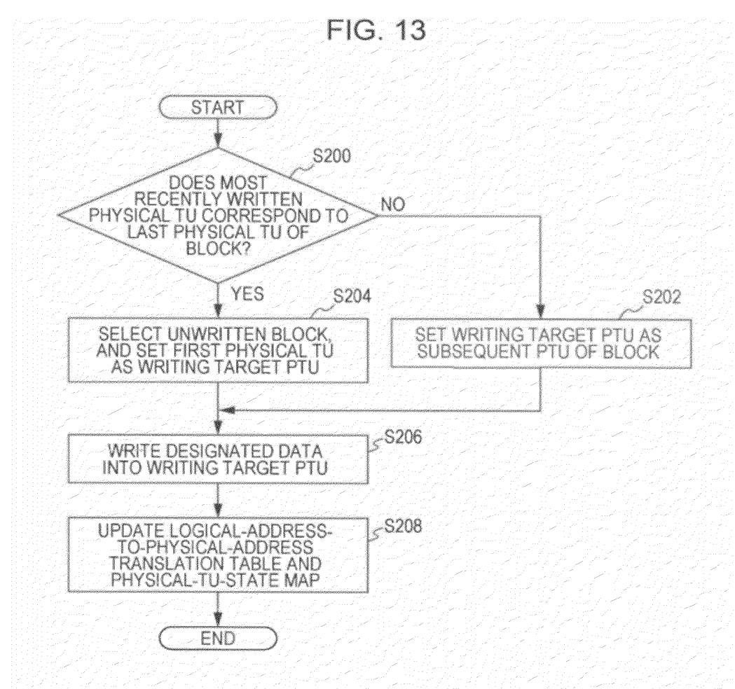

FIG. 13 is a flowchart illustrating an example of the processing of writing data according to the embodiment of the disclosure.

The administration device 100 determines whether or not the most recently written physical TU is the last physical TU in the block (S200). If it is not determined in step S200 that the physical TU is the last physical TU in the block, the administration device 100 sets the subsequent PTU in the block as a writing target PTU (S202), and performs the processing from step S206 to be described later.

Further, if it is determined in step S200 that the physical TU is the last physical TU in the block, the administration device 100 selects a block in which the first physical TU is the “unwritten physical TU”, and sets the first physical TU of the selected block as the writing target PTU (S204).

When the writing target PTU is set in step S202 or step S204, the administration device 100 writes designated data into the corresponding writing target PTU (S206). Then, the administration device 100 updates a logical-address-to-physical-address translation table (a logical-to-physical translation table) and a physical TU state map relating to the logical-address-to-physical-address translation (S208).

The administration device 100 writes data, for example, by performing the processing shown in FIG. 13. In addition, it is needless to say that the writing processing according to the embodiment of the disclosure is not limited to the example shown in FIG. 13.

Referring to FIG. 12 again, the processing relating to the administration method according to the embodiment of the disclosure will be described. In step S100, when data is written, the administration device 100 determines whether or not the initiation condition of the fold processing is satisfied (S102).

If it is not determined in step S102 that the initiation condition of the fold processing is satisfied, the administration device 100 terminates the processing relating to the administration method. In addition, the processing relating to the administration method according to the embodiment of the disclosure is not processing which is completed when being terminated once, and is repeatedly performed whenever data is written.

Further, if it is determined in step S102 that the initiation condition of the fold processing is satisfied, the administration device 100 performs the multi-fold processing (S106).

Examples of Multi-Fold Processing

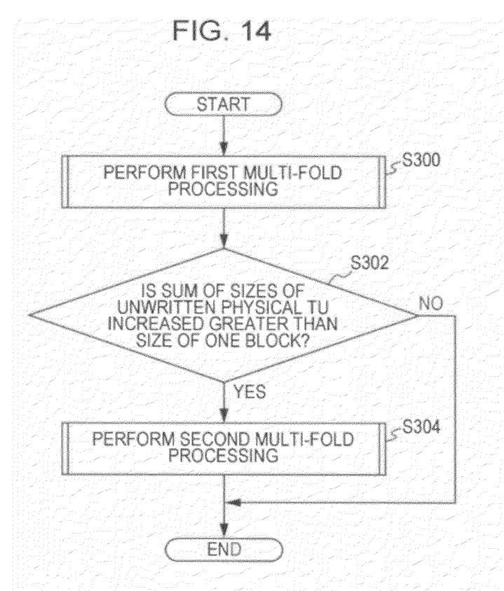

FIG. 14 is a flowchart illustrating an example of the multi-fold processing according to the embodiment of the disclosure.

The administration device 100 performs the first multi-fold processing (S300). Here, the first multi-fold processing according to the embodiment of the disclosure is defined as multi-fold processing using, as the stopping condition, for example a condition in which the size of the “unwritten physical translation units” increased through the fold processing is equal to or greater than the block size.

Example of First Multi-Fold Processing

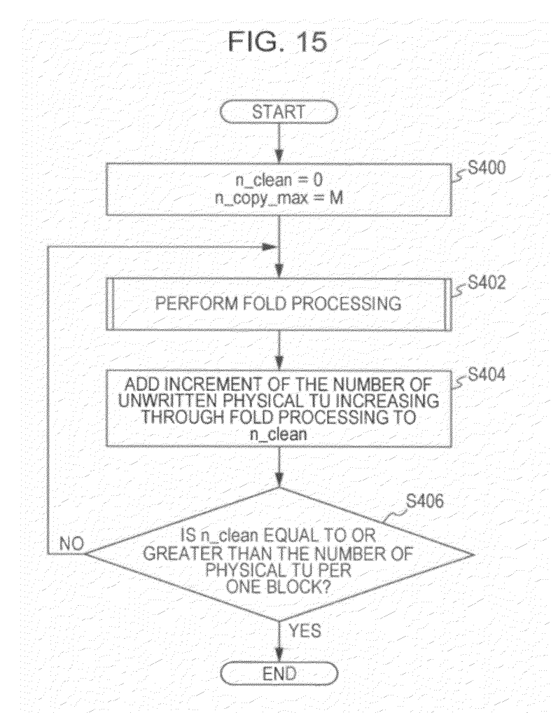

FIG. 15 is a flowchart illustrating an example of the first multi-fold processing according to the embodiment of the disclosure.

The administration device 100 sets the value of “n_clean” to n_clean=0 (zero), and sets the value of “n_copy_max” to n_copy_max=M (M is a value sufficiently greater than the number of physical TUs contained in the block) (S400). Here, “n_clean” is used to keep the number of the unwritten physical translation units increased through the fold processing. Further, “n_copy_max” is used for the determination in the fold processing to be described later. Furthermore, the processing of step S400 corresponds to processing of initializing the value of “n_clean”.

When the initialization processing is performed in step S400, the administration device 100 performs the fold processing (S402).

Example of Fold Processing

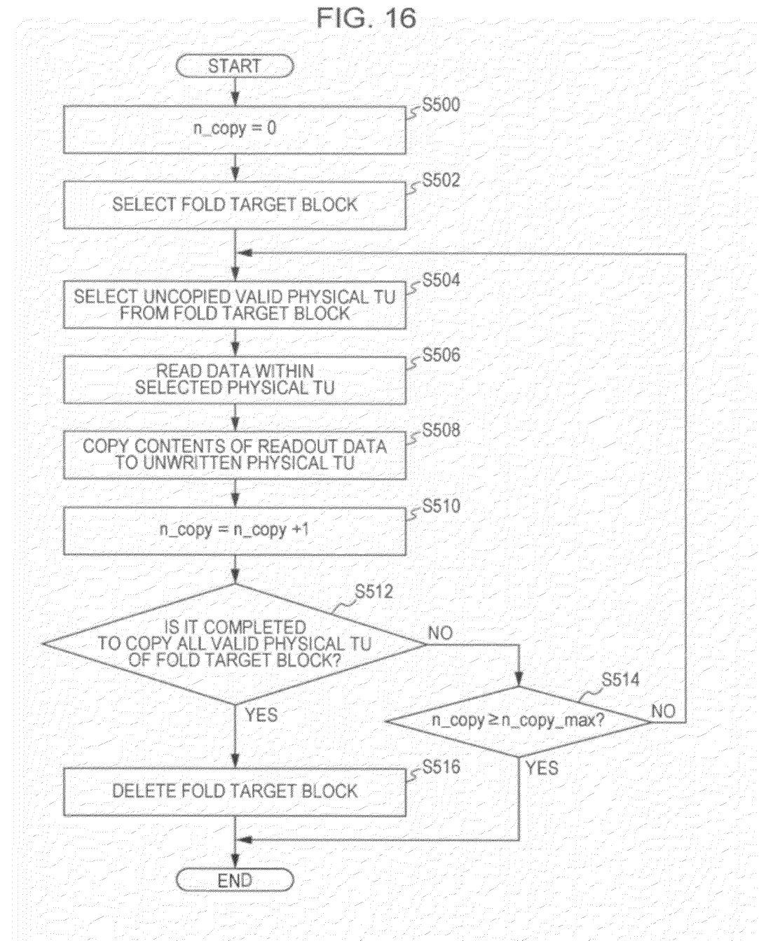

FIG. 16 is a flowchart illustrating an example of the fold processing according to the embodiment of the disclosure.

The administration device 100 sets the value of “n_copy” to n_copy=0 (zero) (S500). Here, “n_copy” is a sort of counter for keeping the number of physical TUs in which data is copied. Further, the processing of step S500 corresponds to processing of initializing the value of “n_copy”.

When performing the processing of step S500, the administration device 100 selects a block (hereinafter referred to as a “fold target block”) as a fold processing target (S502). Here, for example, the administration device 100 selects, as the fold target block, a block, which has a larger number of the “written invalid physical translation units”, among the blocks in the nonvolatile memory, but the selection method is not limited to the above.

When the fold target block is selected in step S502, the administration device 100 selects the uncopied “written valid physical TU” from the fold target block (S504). When the uncopied “written valid physical TU” is selected in step S504, the administration device 100 reads out data within the selected physical TU (S506), and copies the readout data to the unwritten PTU in the copy destination block (S508). Then, the administration device 100 updates the value of “n_copy” to n_copy=n_copy+1 (S510).

When performing the processing of step S510, the administration device 100 determines whether or not copying of data of all the written valid physical TUs contained in the fold target block is completed (S512).

If it is not determined in step S512 that copy of the data is completed, the administration device 100 determines whether or not “n_copy≧n_copy_max” (S514). In the first multi-fold processing, as the value of “n_copy_max”, M (M is a value sufficiently greater than the number of physical TUs contained in the block) is set. Therefore, the administration device 100 repeats the processing from step S504. Further, in the second multi-fold processing to be described later, the value of “n_copy_max” is set to a value other than M. Thereby, the administration device 100 selectively repeats the processing from step S504 on the basis of the determination result of step S514.

Further, if it is determined in step S512 that copy of the data is completed, the administration device 100 erases the fold target block (S506), and terminates the fold processing.

The administration device 100 performs, for example, the processing shown in FIG. 16, thereby implementing the fold processing. In addition, it is needless to say that the fold processing according to the embodiment of the disclosure is not limited to the example shown in FIG. 16.

Referring to FIG. 15 again, an example of the first multi-fold processing according to the embodiment of the disclosure will be described. When the fold processing is performed in step S402, the administration device 100 adds the number of the unwritten physical translation units increased through the fold processing to the value of “n_clean” (S404). Then, the administration device 100 determines whether or not the value of “n_clean” is equal to or greater than the number of physical TUs per block (S406).

If it is not determined in step S406 that the value of “n_clean” is equal to or greater than the number of physical TUs per block, the administration device 100 repeats the processing from step S402.

Further, if it is determined in step S406 that the value of “n_clean” is equal to or greater than the number of physical TUs per block, the administration device 100 terminates the first multi-fold processing.

The administration device 100 performs, for example, the processing shown in FIG. 15, thereby implementing the first multi-fold processing. In addition, it is needless to say that the first multi-fold processing according to the embodiment of the disclosure is not limited to the example shown in FIG. 15.

Referring to FIG. 14 again, an example of the multi-fold processing according to the embodiment of the disclosure will be described. When performing the processing of step S300, the administration device 100 determines whether or not the total size of the unwritten physical translation units increased through the fold processing exceeds the size of a single block (S302). Here, the administration device 100 determines that the total size thereof exceeds the size of a single block for example when the value of “n_clean” exceeds the number of physical TUs per block, but the determination method in step S302 is not limited to the above.

If it is not determined in step S302 that the total size thereof exceeds the size of a single block, the administration device 100 performs the second multi-fold processing (S304). Here, the second multi-fold processing according to the embodiment of the disclosure is, for example as shown in FIGS. 9A to 9D, multi-fold processing of filling the size exceeding the size (an example of the predetermined size based on the block size) of the single block with the data of the “written valid physical translation unit.

Example of Second Multi-Fold Processing

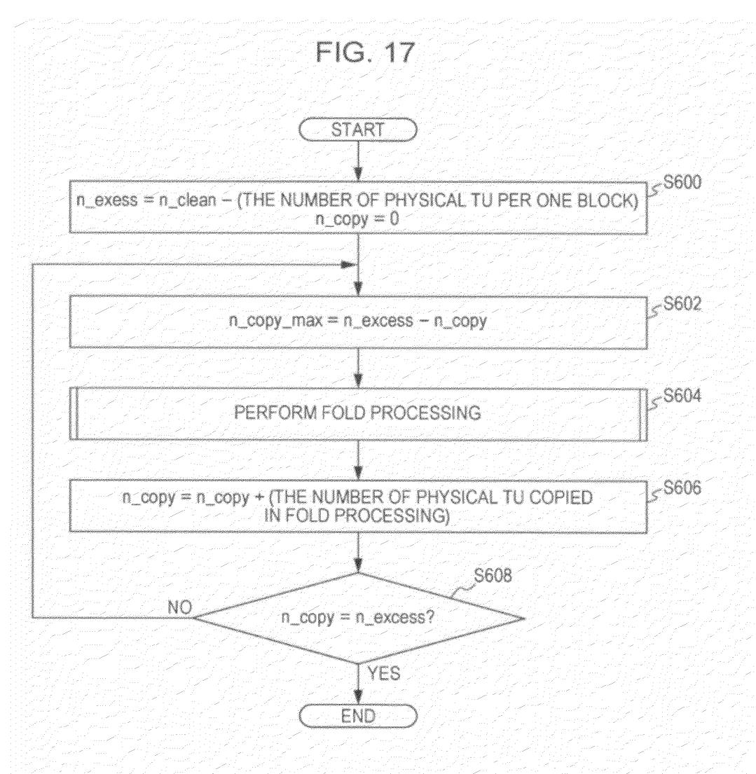

FIG. 17 is a flowchart illustrating an example of second multi-fold processing according to the embodiment of the disclosure.

The administration device 100 sets the value of “n_excess” to n_excess=n_clean−(the number of physical TUs per block), and sets the value of “n_copy” to n_copy=0 (zero) (S600). Here, “n_excess” represents the number of physical TUs corresponding to the size exceeding the size of a single block. Further, the processing of step S600 corresponds to processing of initializing the value of “n_copy”.

When performing the processing of step S600, the administration device 100 sets the value of “n_copy_max” to n_copy_max=n_excess-n_copy (S602).

When performing the processing of step S602, the administration device 100 performs the fold processing (S604). Here, the administration device 100 performs, for example, the processing shown in FIG. 16 as the fold processing.

When performing the processing of step S604, the administration device 100 updates the value of “n_copy” to n_copy=n_copy+(the number of physical TUs copied in the fold processing) (S606).

When performing the processing of step S606, the administration device 100 determines whether or not n_copy=n_excess (S608). If it is not determined in step S608 that n_copy=n_excess, the administration device 100 repeats the processing from step S602.

Further, if it is determined in step S608 that n_copy=n_excess, the administration device 100 terminates the second multi-fold processing.

The administration device 100 performs, for example, the processing shown in FIG. 17, thereby implementing the second multi-fold processing. In addition, it is needless to say that the second multi-fold processing according to the embodiment of the disclosure is not limited to the example shown in FIG. 17.

Referring to FIG. 14 again, an example of the multi-fold processing according to the embodiment of the disclosure will be described. If it is not determined in step S302 that the total size thereof exceeds the size of a single block, the administration device 100 terminates the multi-fold processing.

The administration device 100 performs, for example, the processing shown in FIG. 14, thereby implementing the multi-fold processing. In addition, it is needless to say that the multi-fold processing according to the embodiment of the disclosure is not limited to the example shown in FIG. 14. For example, the administration device 100 may perform only the first multi-fold processing shown in FIG. 15 as the multi-fold processing.

Referring to FIG. 12 again, the processing relating to the administration method according to the embodiment of the disclosure will be described. When the multi-fold processing is terminated in step S106, the administration device 100 terminates the processing relating to the administration method.

The administration device 100 performs, for example, the processing shown in FIG. 12, whereby it is possible to implement the above-mentioned administration method according to the embodiment of the disclosure. Accordingly, the administration device 100 performs, for example, the processing shown in FIG. 12, whereby it is possible to increase efficiency in securing the free space in the nonvolatile memory. In addition, it is needless to say that the processing relating to the administration method according to the embodiment of the disclosure is not limited to the example shown in FIG. 12.

### 2. Administration Device According to Embodiment of the Disclosure

Next, a description will be given of a configuration of the administration device 100 according to the embodiment of the disclosure capable of performing the above-mentioned processing relating to the administration method according to the embodiment of the disclosure.

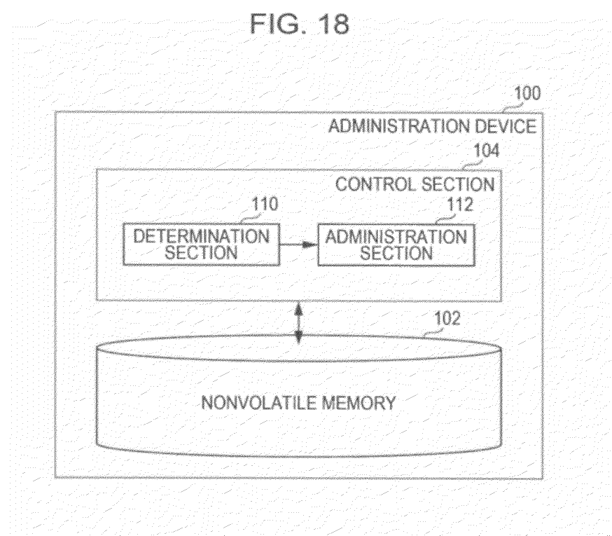

FIG. 18 is a block diagram illustrating an example of the configuration of the administration device 100 according to the embodiment of the disclosure. The administration device 100 includes, for example, nonvolatile memory 102 and a control section 104.

Further, the administration device 100 may include, for example: a ROM (Read Only Memory, not shown in the drawing); a RAM (Random Access Memory, not shown in the drawing); an operation section (not shown in the drawing) that can be operated by a user; a display section (not shown in the drawing) that displays various contents on the display screen; and a communication section (not shown in the drawing) that is for communicating with external devices. The administration device 100 interconnects, for example, the respective components through a bus as a data transmission path.

The ROM (not shown in the drawing) stores control data such as operation parameters and programs used by the control section 104. The RAM (not shown in the drawing) temporarily stores programs executed by the control section 104. As the operation section (not shown in the drawing), for example, an operation device to be described later can be given, and as the display section (not shown in the drawing), for example, a display device to be described later can be given. Further, as the communication section (not shown in the drawing), for example, a communication interface to be described later can be given.

Hardware Exemplary Configuration of Administration Device 100

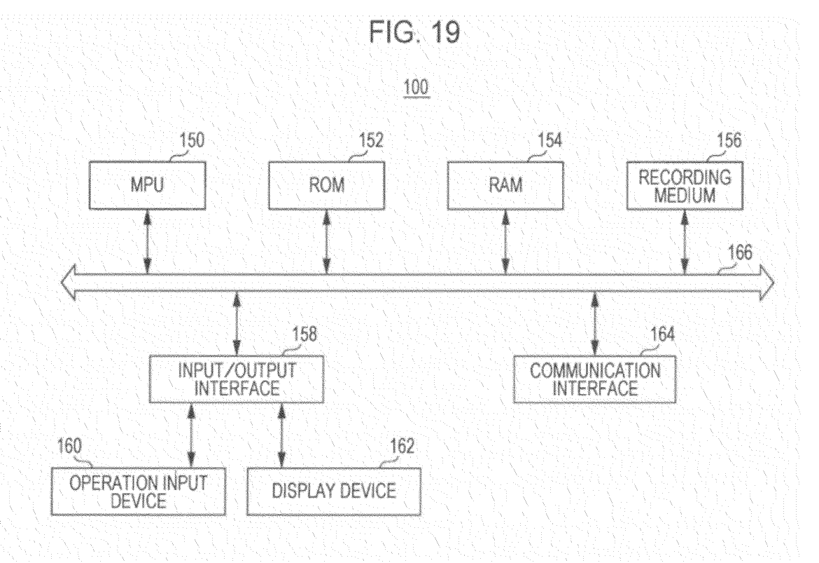

FIG. 19 is an explanatory diagram illustrating an example of the hardware configuration of the administration device 100 according to the embodiment of the disclosure. Referring to FIG. 19, the administration device 100 includes, for example: an MPU 150; a ROM 152; a RAM 154; a recording medium 156; an input/output interface 158; an operation input device 160; a display device 162; and a communication interface 164. Further, the administration device 100 interconnects, for example, the respective components through the bus 166 as a data transmission path.

The MPU 150 is constituted by an integrated circuit, in which various circuits to realize an MPU (Micro Processing Unit) and various functions such as a control function are integrated, and the like, and functions as the control section 104 that controls the whole administration device 100. Further, in the administration device 100, the MPU 150 can also play a role of the determination section 110 and the administration section 112 to be described later.

The ROM 152 stores control data such as operation parameters and programs used by the MPU 150, and the RAM 154 temporarily stores, for example, programs executed by the MPU 150 and the like.

The recording medium 156 is storage means in the administration device 100, and functions as the nonvolatile memory 102. The recording medium 156 stores, for example, applications, various kinds of data, and the like. Here, as the recording medium 156, for example, a flash memory and the like can be given. Further, the recording medium 156 may be configured to be removable from the administration device 100.

The input/output interface 158 interconnects, for example, the operation input device 160 and the display device 162. The operation input device 160 functions as an operation section (not shown in the drawing), and the display device 162 functions as the display section (not shown in the drawing). Here, as the input/output interface 158, for example, a USB (Universal Serial Bus) terminal, a DVI (Digital Visual Interface) terminal, an HDMI (High-Definition Multimedia Interface) terminal, various kinds of processing circuits, and the like can be given. Further, the operation input device 160 is provided, for example, in the administration device 100, and is connected to the input/output interface 158 inside the administration device 100. As the operation input device 160, for example, a button, an arrow key, a rotary-type selector such as a jog dial, or a combination of these can be given. Furthermore, the display device 162 is provided, for example, in the administration device 100, and is connected to the input/output interface 158 inside the administration device 100. As the display device 162, for example, a liquid crystal display (LCD) and an organic EL display (also called organic Electro Luminescence display or an OLED display (Organic Light Emitting Diode display)) can be given. In addition, it is needless to say that the input/output interface 158 is connected to an operation input device (for example, a keyboard or mouse) or a display device (for example, an external display, or the like) as an external device of the administration device 100. Further, the display device 162 may be a device, such as a touch screen, capable of performing display and user operations.

The communication interface 164 is a communication means provided in the administration device 100, and functions as a communication section (not shown in the drawing) to perform wired and wireless communication with the external device via the network (or directly). Here, as the communication interface 164, for example, a communication antenna and RF (Radio Frequency) circuit (wireless communication), and a LAN terminal and a transmission and reception circuit (wire communication), and the like can be given. Further, the communication interface 164 according to the embodiment of the disclosure is not limited to the above-mentioned configuration, and may have, for example, a configuration compatible with the network.

With the configuration shown for example in FIG. 19, the administration device 100 performs the above-mentioned processing relating to the administration method according to the embodiment of the disclosure. Further, the hardware configuration of the administration device 100 according to the embodiment of the disclosure is not limited to the configuration shown in FIG. 19. For example, the administration device 100 may be applied to an IC (Integrated Circuit) for implementing functions (for example, functions of the determination section 110 and the administration section 112) of performing the processing relating to the administration method according to the embodiment of the disclosure.

Referring to FIG. 18 again, an example of the configuration of the administration device 100 will be described. The nonvolatile memory 102 is storage means provided in the administration device 100. Here, as the nonvolatile memory 102, for example, a flash memory or the like can be given. In the nonvolatile memory 102, writing, reading, and erasing of data are administered through the control section 104 (more specifically, the determination section 110 and the administration section 112 to be described later).

The control section 104 is constituted by, for example, the MPU and the like, and plays a role of controlling the whole administration device 100. Further, the control section 104 includes the determination section 110, the administration section 112, and plays a leading role in performing the processing relating to the administration method according to the embodiment of the disclosure.

The determination section 110 plays a leading role in performing the processing of (1) (the processing of determining the initiation condition). More specifically, the determination section 110 determines whether or not the initiation condition for initiating the fold processing is satisfied. Then, if it is determined that the corresponding initiation condition is satisfied, the determination section 110 transfers, for example, a processing initiation request (a sort of a trigger) to initiate the fold processing to the administration section 112.

The administration section 112 plays a leading role in performing the processing of (2) (the fold processing). More specifically, the administration section 112 selectively initiates the fold processing, for example, when the processing initiation request is transferred. Further, for example, when initiating the fold processing, the administration section 112 copies the data of the written valid physical translation units into a block, in which the first physical translation unit is unwritten, among the blocks in which the unwritten physical translation units reside. Furthermore, the administration section 112 repeats the fold processing, for example, until the size of the unwritten physical translation units increased through the fold processing is equal to or greater than the block size (an example of the predetermined size based on the block size).

The control section 104 includes, for example, the determination section 110 and the administration section 112, so as to thereby perform the processing of (1) (the processing of determining the initiation condition) and the processing of (2) (the fold processing). Accordingly, the control section 104 includes, for example, the determination section 110 and the administration section 112, whereby it is possible to implement the above-mentioned processing relating to the administration method according to the embodiment of the disclosure. Therefore, it is possible to increase efficiency in securing the free space in the nonvolatile memory 102.

Further, the configuration of the control section 104 according to the embodiment of the disclosure is not limited to the example shown in FIG. 18. For example, the control section 104 according to the embodiment of the disclosure may be configured to not include the determination section 110. Even in the case of the above configuration, the administration device 100 according to the embodiment of the disclosure is able to perform the processing of (2) (the fold processing) on the basis of, for example, the operation signal for the request which is transferred from the operation section (not shown in the drawing) in order to initiate the fold processing.

With the configuration shown in for example FIG. 18, the administration device 100 performs the above-mentioned processing relating to the administration method according to the embodiment of the disclosure. Accordingly, the administration device 100 is able to increase efficiency in securing the free space in the nonvolatile memory 102.

Further, the configuration of the administration device 100 according to the embodiment of the disclosure is not limited to the example shown in FIG. 18. For example, the administration device 100 according to the embodiment of the disclosure may be configured to write, read, and erase data in the nonvolatile memory, which is provided in the external device connected through the wire or wireless communication, without the nonvolatile memory 102. Even in the case of the above configuration, the administration device 100 according to the embodiment of the disclosure is able to increase efficiency in securing the free space in the nonvolatile memory which is provided in the external device.

As described above, in the related art, the fold processing is performed once, while the administration device 100 according to the embodiment of the disclosure repeatedly performs the fold processing until the prescribed stopping condition is satisfied (the multi-fold processing). Here, the system using the nonvolatile memory may be for example a file system such as the FAT system. In this case, when the rewriting is performed in an access pattern (the rewriting sequence) of certain logical translation units, there is a high possibility that the rewriting will be performed in the same access pattern as the corresponding access pattern in the future. By causing the administration device 100 to perform the multi-fold processing, as described above, when the rewriting is performed in the same access pattern of the logical translation units in the future, the physical translation units contained in the block subjected to the rewriting are converted into the “written invalid physical translation units”. Accordingly, as compared with the fold processing according to the related art shown in FIGS. 6A to 6H, the administration device 100 is able to further efficiently secure the free space of the nonvolatile memory.

Further, the administration device 100 is able to further efficiently secure the free space of the nonvolatile memory. Therefore, from the viewpoint of a user, it is possible to achieve improvement in performance of data rewriting in the nonvolatile memory and an increase in lifetime of the nonvolatile memory such as the NAND flash memory.

Furthermore, the administration device 100 performs the fold processing when the initiation condition including the condition relating to the writing of data is satisfied. Therefore, for example, when writing data, it is possible to distributively perform the multi-fold processing. Accordingly, the administration device 100 may not perform the fold processing as background processing. Hence, for example, it is possible to prevent an effect (such as deterioration in processing performance), which is caused by unexpectedly performing the fold processing as the background processing, from being imposed on another processing.

In addition, the administration device 100 is able to set, as the initiation condition, a condition in which the writing, reading, and erasing of data are not performed in the nonvolatile memory (in other words, the system is in a so-called idle state). Accordingly, in the above-mentioned case, the administration device 100 is able to effectively use the idle state of the system.

As the embodiment of the disclosure, the administration device 100 has hitherto been described, but the embodiment of the disclosure is not limited to such a form. The embodiment of the disclosure can be applied to various devices including, for example: a storage device using the nonvolatile memory; a computer such as a PC (Personal Computer) or a server; a display device such as a television set; a mobile communication apparatus such as a mobile phone; a video/music reproducer (or a video/music recorder); a games machine; and the like. Further, the embodiment of the disclosure may be applied to, for example, the control ICs of the recording media built into the various devices.

### 3. Program According to Embodiment of the Disclosure

It is possible to increase efficiency in securing the free space in the nonvolatile memory by using a program for causing a computer to function as the administration device according to the embodiment of the disclosure (for example, a program for implementing the processing of (1) (the processing of determining the initiation condition) and the processing of (2) (the fold processing), or the processing, such as the processing of (2) (the fold processing), relating to the administration method according to the embodiment of the disclosure). Further, by using the program for causing a computer to function as the administration device according to the embodiment of the disclosure, from the viewpoint of a user, it is possible to achieve improvement in performance of data rewriting in the nonvolatile memory and an increase in lifetime of the nonvolatile memory such as the NAND flash memory.

The preferred embodiments of the disclosure have been described above with reference to the accompanying drawings, but it is needless to say that the disclosure is not limited to the above examples. It will be readily apparent to a person skilled in the art that obvious modifications, derivations, and variations can be made without departing from the technical scope described in the claims appended hereto. In addition, it should be understood that such modifications, derivations, and variations belong to the technical scope of the disclosure.

For example, the administration device according to the embodiment of the disclosure may separately include the determination section 110 and the administration section 112 shown in FIG. 18 (for example, the respective sections are embodied by separate processing circuits).

Further, in the above description, there is provided the program (the computer program) for causing a computer to function as the administration device according to the embodiment of the disclosure. However, in the embodiment of the disclosure, it is possible to further provide a recording medium storing the program.

Since the above-mentioned configurations are examples of the embodiments of the disclosure, it should be understood that the configurations belong to the technical scope of the disclosure.

The present disclosure contains subject matter related to that disclosed in Japanese Priority Patent Application JP 2010-286318 filed in the Japan Patent Office on Dec. 22, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An administration device comprising an administration section that
administers writing, reading, and erasing of data in a nonvolatile memory, in which the data can be electrically written, read, and erased and the writing and the reading are performed on a page-by-page basis and the erasing is performed on a block-by-block basis where each block includes a plurality of pages, by translating a logical address into a physical address on a per translation unit basis having a size equal to 1/n of a size of the block where n is an integer and an integer multiple of a size of the page, and
performs fold processing of increasing unwritten physical translation units by the number of written invalid physical translation units, which are contained in a block of a copy source, by copying data of written valid physical translation units among the contents of the block into a block, in which the unwritten physical translation units reside, and by erasing the block of the copy source,
wherein when initiating the fold processing, the administration section
copies the data of the written valid physical translation units into a block, in which a first physical translation unit is unwritten, among blocks, in which the unwritten physical translation units reside, and
repeats the fold processing until a size of the unwritten physical translation units increased through the fold processing is equal to or greater than a size of the block.

2. The administration device according to claim 1, wherein after the fold processing is performed, when the size of the unwritten physical translation units increased through the fold processing is indivisible by the size of the block, the administration section copies the data of the written valid physical translation units through the fold processing by the size of the unwritten physical translation units corresponding to a size of a fraction thereof.

3. The administration device according to claim 1, further comprising a determination section that determines whether or not an initiation condition for initiating the fold processing in the administration section is satisfied,
wherein the administration section selectively performs the fold processing when the determination section determines that the initiation condition is satisfied.

4. The administration device according to claim 3, wherein the determination section performs the determination under the initiation condition in which a write location of data most recently written by the administration section is a last physical translation unit in the block and the number of the blocks of data being written is greater than a predetermined threshold value or is not less than the threshold value.

5. The administration device according to claim 4, wherein the determination section performs the determination under the initiation condition in which the writing, the reading, and the erasing of data is not performed in the nonvolatile memory.

6. The administration device according to claim 3, wherein the determination section performs the determination under the initiation condition in which a write location of data most recently written by the administration section is a last physical translation unit in the block and the number of the blocks not containing written data is less than a predetermined threshold value or is not more than the threshold value.

7. The administration device according to claim 1, wherein the administration section does not stop the fold processing even when the size of the unwritten physical translation units increased through the fold processing is equal to or more than the size of the block, and repeats the fold processing until the size of the unwritten physical translation units is equal to or more than a predetermined integer multiple of the size of the block.

8. The administration device according to claim 1, wherein the administration section selects a block, in which the number of the written invalid physical translation units is larger, among the blocks in the nonvolatile memory as a block of a copy source in the fold processing.

9. The administration device according to claim 1, wherein when performing the fold processing, the administration section causes a block including a physical translation unit, which corresponded to a logical translation unit containing most recently written data before the most recent writing, to not be subjected to the fold processing.

10. The administration device according to claim 1, wherein when performing the fold processing, the administration section copies the data of the written valid physical translation units within the block in ascending order of numbers which are respectively assigned to the physical translation units.

11. The administration device according to claim 1, wherein when performing the fold processing, the administration section copies the data of the written valid physical translation units within the block in ascending order of numbers which are respectively assigned to the logical translation units respectively corresponding thereto.

12. The administration device according to claim 1, wherein when performing the fold processing, the administration section specifies the written valid physical translation units in all the blocks as the copy sources in the fold processing repeatedly performed, and copies data of the specified physical translation units in ascending order of numbers which are respectively assigned to the logical translation units respectively corresponding to the specified physical translation units.

13. The administration device according to claim 1, further comprising the nonvolatile memory.

14. An administration method comprising:
administering writing, reading, and erasing of data in a nonvolatile memory, in which the data can be electrically written, read, and erased and the writing and the reading are performed on a page-by-page basis and the erasing is performed on a block-by-block basis where each block includes a plurality of pages, by translating a logical address into a physical address on a per translation unit basis having a size equal to 1/n of a size of the block where n is an integer and an integer multiple of a size of the page; and
determining whether or not an initiation condition is satisfied, where the condition is for initiating fold processing of increasing unwritten physical translation units by the number of written invalid physical translation units, which are contained in a block of a copy source, by copying data of written valid physical translation units among the contents of the block into a block, in which the unwritten physical translation units reside, and by erasing the block of the copy source,
wherein in the administering of the writing, the reading, and the erasing, if it is determined that the initiation condition is satisfied, the fold processing is selectively performed, and
wherein when the fold processing is initiated,
the data of the written valid physical translation units is copied into a block, in which a first physical translation unit is unwritten, among blocks in which the unwritten physical translation units reside, and
the fold processing is repeated until a size of the unwritten physical translation units increased through the fold processing is equal to or greater than a size of the block.

15. A program for causing a computer to function as administration means for:
administering writing, reading, and erasing of data in a nonvolatile memory, in which the data can be electrically written, read, and erased and the writing and the reading are performed on a page-by-page basis and the erasing is performed on a block-by-block basis where each block includes a plurality of pages, by translating a logical address into a physical address on a per translation unit basis having a size equal to 1/n of a size of the block where n is an integer and an integer multiple of a size of the page; and
performing fold processing of increasing unwritten physical translation units by the number of written invalid physical translation units, which are contained in a block of a copy source, by copying data of written valid physical translation units among the contents of the block into a block, in which the unwritten physical translation units reside, and by erasing the block of the copy source,
wherein when initiating the fold processing, the administration section
copies the data of the written valid physical translation units into a block, in which a first physical translation unit is unwritten, among blocks, in which the unwritten physical translation units reside, and
repeats the fold processing until a size of the unwritten physical translation units increased through the fold processing is equal to or greater than a size of the block.
